(19) United States
(12) Patent Application Publication
(10) Pub. No.: US 2011/0017693 A1
(43) Pub. Date: Jan. 27, 2011

(54) CONTAINER TRACKING AND LOCATING SYSTEMS, METHODS, AND COMPUTER PROGRAM PRODUCTS

(75) Inventors: Patrick Thomas, San Diego, CA (US); Allen Thomas, Charlotte, NC (US); Leroy Scheppmann, II, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: APS Technology Group, Inc., San Diego, CA (US)

(21) Appl. No.: 12/840,983

(22) Filed: Jul. 21, 2010

Related U.S. Application Data
(60) Provisional application No. 61/227,261, filed on Jul. 21, 2009.

(51) Int. Cl. B66C 13/18; G06F 19/00; B66C 19/00; H04Q 5/22; G06T 7/00

(52) U.S. Cl. 212/270; 700/225; 700/213; 340/10.42; 382/103

(57) ABSTRACT

Provided are systems, methods, and computer-program products for tracking and locating shipping containers in rail car unloading operations in a railway switchyard using a rail mounted gantry crane. The systems, methods, and computer program products configured to establish the position of shipping containers loaded on rail cars within a rail yard. The position of the shipping containers can be conveyed in terms of relative or absolute coordinates. The systems, methods, and computer program products can use a variety of inputs, rules, and calculations to establish the final resting places of containers mounted on rail cars. The position information may be used to provide various functionality, including creating a log or record of the location of containers or to guide rail mounted gantry (RMG) cranes to unload and work the train(s) of interest.

### CROSS-REFERENCE TO RELATED CASE

This patent application claims priority to U.S. Provisional Patent Application No. 61/227,261, filed Jul. 21, 2009, titled “CONTAINER TRACKING AND LOCATING SYSTEMS, METHODS, AND COMPUTER PROGRAM PRODUCTS,” which is hereby incorporated by reference in its entirety.

### FIELD

Embodiments of the present invention relate generally to shipping container tracking and locating and, more particularly, to systems, methods, and computer-program products for tracking and locating shipping containers in rail car unloading operations in a railway switchyard using a rail mounted gantry crane.

### BACKGROUND

Very large rail yards are used for loading, unloading, shuffling, transferring, and otherwise moving containers on rail cars. All of this movement occurs on what can be a large number of parallel tracks in the yard specifically designed for this operation. Large, rail-mounted gantry cranes which span a number of tracks are used to move over the trains and do the loading and unloading.

Trains, rail cars, and the containers are moved onto these tracks over a switch network (railway switchyard) that can rearrange the order, sequence, and combinations of cars. As a result, when all the movement comes to a stop, the trains and their parts (e.g., rail cars and containers) are often rearranged and out of order. There is a need for improved, automated processes for tracking and locating shipping container in these circumstances.

### SUMMARY

Embodiments discussed herein include systems, methods, and computer program products configured to establish the relative or absolute position of shipping containers loaded on rail cars within a rail yard. Some embodiments provide for a complex system that uses a variety of inputs, rules, and calculations to establish the resting place of a container mounted on a rail car in a rail yard. Information identifying the resting place (sometimes referred to herein as “container location”) can be used to guide a rail mounted gantry (“RMG”) crane to enable, for example, the RMG crane to unload and work the train of interest.

For example, a RMG crane can be instructed to move over a container by providing location information for laterally positioning the trolley, which moves side-to-side over the tracks, and for longitudinally positioning the RMG crane along the tracks, which gantries linearly (parallel) to the tracks. The container location is used to move the crane to the location of the container, as near as possible to the exact location of the container, but not necessarily for the actual hoisting or the physical latching processes, which may involve more sensitive positioning after the crane has moved over a container, at least for an initial target container in a series of continuous rail cars.

These characteristics as well as additional exemplary features, functions, and details of embodiments of the present invention are described below. Similarly, corresponding and additional embodiments of systems and related methods and computer program products of the present invention are also described below.

### BRIEF DESCRIPTION OF THE DRAWINGS

Having thus described embodiments of the invention in general terms, reference will now be made to the accompanying drawings, which are not necessarily drawn to scale, and wherein:

FIG. 1A shows a rail mounted gantry crane across the tracks of a railway switchyard and FIG. 1B shows a detailed view of a portion of the railway switchyard of FIG. 1, which are in accordance with some embodiments of the present invention;

FIG. 2 shows a second example of rail mounted gantry cranes across the tracks of a railway switchyard in accordance with some embodiments of the present invention;

FIG. 3 shows a train, rail cars, and containers passing through an optical character recognition portal in accordance with some embodiments of the present invention;

FIGS. 4A-4C show the rail mounted gantry crane of FIGS. 1A and 1B outfitted with cameras and other sensors in accordance with some embodiments of the present invention;

FIG. 5 shows a data accumulation diagram of a method of in accordance with some embodiments of the present invention;

FIG. 6 is a functional block diagram of a system and method in accordance with some embodiments of the present invention;

FIG. 7 is a schematic block diagram of a system in accordance with some embodiments of the present invention;

FIG. 8 is a schematic block diagram of a system in accordance with some embodiments of the present invention;

FIG. 9 shows a locomotive, having wireless communications, positioning train cars within the working area of the rail mounted gantry crane of FIGS. 1A and 1B in accordance with some embodiments;

FIG. 10 shows the locomotive of FIG. 9 passing through the optical character recognition portal of FIG. 3 in accordance with some embodiments; and

FIG. 11. shows a functional block diagram of a process in accordance with some embodiments of the present invention.

### DETAILED DESCRIPTION

Embodiments of the present invention will now be described more fully hereinafter with reference to the accompanying drawings, in which some, but not all embodiments of the invention are shown. Indeed, embodiments of the present invention may be embodied in many different forms and should not be construed as limited to the embodiments set forth herein; rather, these embodiments are provided so that this disclosure will satisfy applicable legal requirements. Like reference numbers refer to like elements throughout.

Some embodiments discussed herein enable enhanced automation of the crane process, including the ability to identify, store and retrieve container location information associated with one or more of containers on the train(s). The container location information may be relative location information (e.g., based on the location of one or more other known locations of other containers), absolute location information (e.g., based on specific coordinates, landmarks, etc.), or combination thereof.

On a given track, for example, there may be one or more un-linked individual train segments (such as, e.g., one or more rail cars). Some embodiments discussed herein can be configured to dynamically monitor and/or track, and then possibly re-find, re-establish, or otherwise confirm the location of individual, specific containers so that a moving crane can be automatically positioned to work those containers. Additionally, some embodiments discussed herein can accommodate a large number of variables and compensate for some errors that may occur.

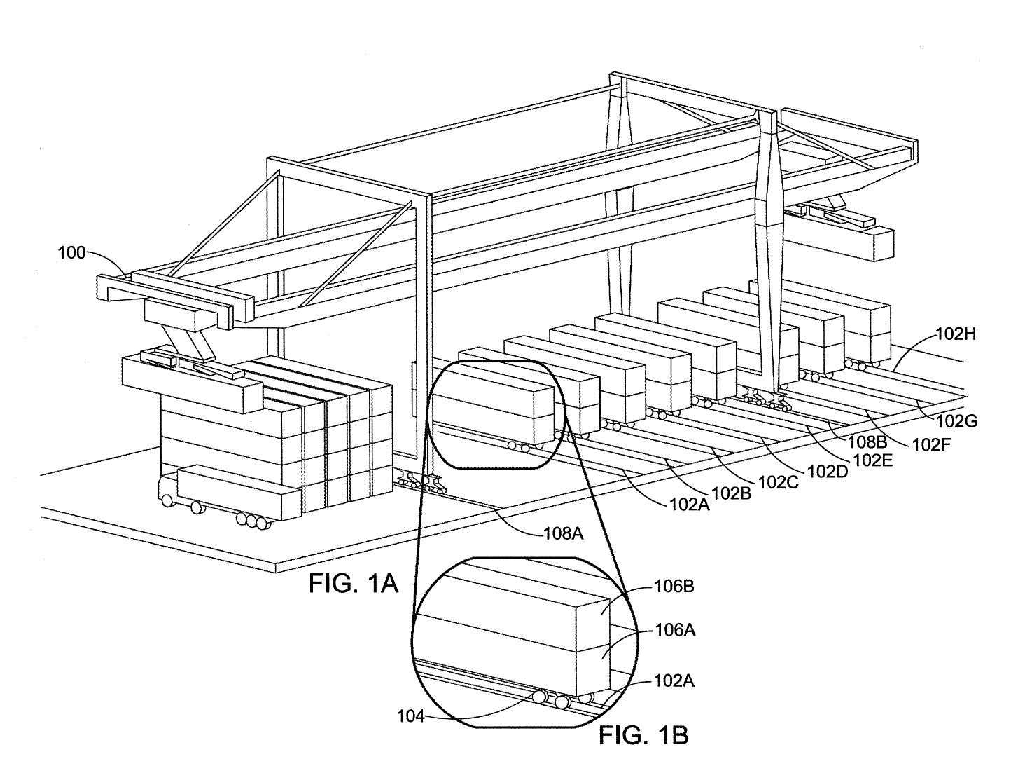

For example, FIG. 1A shows RMG crane 100 spanning over tracks 102A, 102B, 102C, 102D, 102E, 102F, 102G, and 102H. Rail cars are shown on each of tracks 102A-102H. Each rail car shown in FIG. 1 has two shipment containers stacked thereon. For example, FIG. 1B shows a detailed view of rail car 104 on track 102A. Lower container 106A and upper container 106B are shown as being stacked on rail car 104.

RMG crane 100 can also be mounted on tracks, such as tracks 108A and 108B shown in FIG. 1. RMG crane 100 can move over tracks 108A and 108B and span over, for example, 3000 feet or more of tracks 102A-102H. In some embodiments, more than one crane can be mounted onto tracks 108A and 108B (or other tracks that are not shown), and also span over tracks 102A-102H. The tracks or portions thereof, such as tracks 102A-102H, that are accessible by one or more cranes, such as RMG crane 100, are sometimes referred herein as the “working area” or “working tracks.” The entrance and/or exit of the working area may include a switching area that divides and/or combines individual tracks. A portal, such as those discussed herein, may be located at the switching area, in the working area, and/or anywhere else.

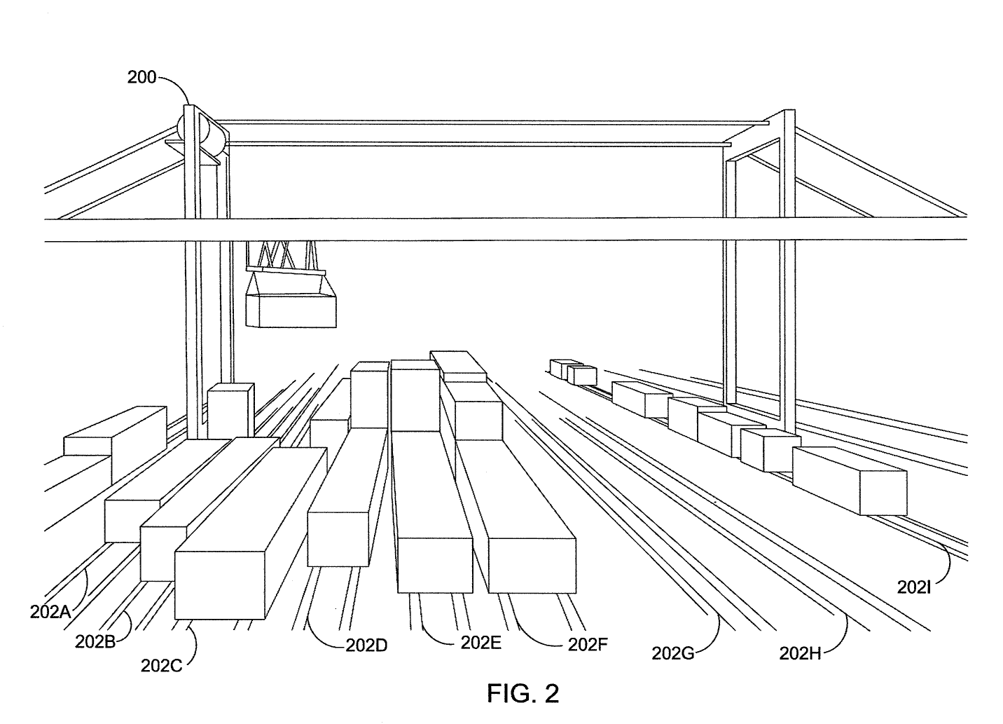

As another example, FIG. 2 shows RMG crane 200, which spans more tracks than RMG crane 100. RMG crane 200 is shown in FIG. 2 as spanning over tracks 202A, 202B, 202C, 202D, 202E, 202F, 202G, 202H, and 202I.

Numerous aspects of existing container and crane operations are described in U.S. Pat. No. 7,508,956 and U.S. Patent Application Publication 2008/0252417, each of which is incorporated by reference in its entirety.

Embodiments discussed herein describe enhanced automation of loading and unloading of rail cars using rail mounted gantry cranes, such as RMG crane 100 and RMG crane 200. Embodiments may include configuring one or more independent systems to exchange and process information. For example, some embodiments may include the use of electronic data information (“EDI”) files, an optical character recognition (“OCR”) portal system that records each shipment container's identifier (“container ID”) and position(s), radio frequency identification (“RFID”) systems that record the train car identifier (“car ID”), switch track data that monitors and logs the track on which each train car is located and/or directed to, an OCR camera system that subsequently re-finds and confirms one or more reference containers, combinations thereof, and/or any other system that may provide input data to a rail track system. The rail track system can be configured to process all the information provided by one or more input systems, establish the final resting place of one or more train cars and its containers, store container location information in nontransitory computer readable media, and/or output human readable container information. A terminal operating system (“TOS”), in accordance with some embodiments discussed herein, can implement the rail track system and provide an integrated exception handling system that efficiently accepts data and resolves errors. Alternatively, a central management system may be separate from and transmit certain data to a TOS.

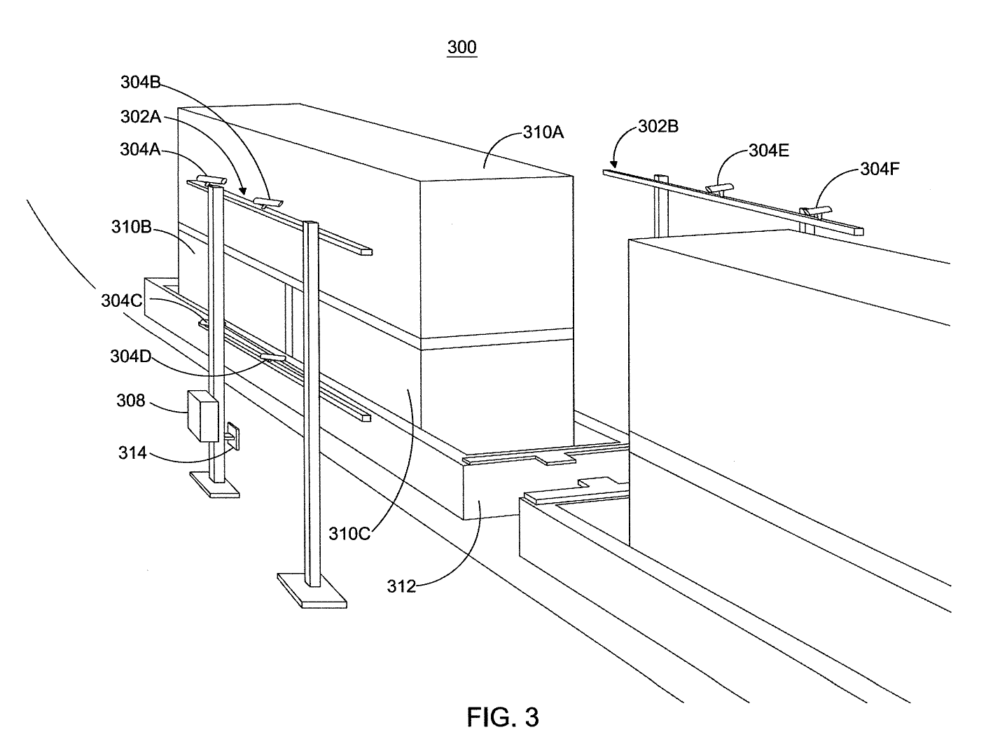

In some embodiments, prior to, subsequent to, or simultaneously with a train car entering and/or exiting the working area, the train cars may move thru one or more OCR portals. FIG. 3, for example, shows OCR portal 300, which includes OCR gate 302A and OCR gate 302B. Each OCR gate may include one or more optical sensors (e.g., camera), RFID reader 314, and/or other type(s) of sensors that may obtain information printed onto and/or broadcast from train cars, containers, and/or other equipment on or otherwise within communicable range of the respective OCR gate. For example, OCR gate 302A is shown as include four cameras, camera 304A, camera 304B, camera 304C and camera 304D. Similarly, OCR gate 302B may include one or more cameras, two of which are shown in FIG. 3. For example, cameras 304E and 304F are shown in FIG. 3. One or more additional cameras may also be included in OCR gate 302B (not shown).

Cameras 304A-304F, RFID reader 314, other sensors and/or other electrical equipment may be configured to provide data to enclosure 308. Enclosure 308 may include, for example, a computer and/or other electronics, including communications circuitry, that enable OCR portal 300 to provide information to a central management system.

FIG. 3 also shows three containers, container 310A, 310B and 310C, occupying one train car, car 312. OCR portal 300 may associate each container as being in a “slot.” For example, OCR portal 300 may read information contained in the indicia written on container 310A, generate corresponding container data, and associate that container data with, e.g., slot “T” (for “top”) of car 312. Similarly, OCR portal 300 may also read information contained in the indicia written on containers 310B and 310C, generate corresponding data for each of the containers, and associate that respective container data with, e.g., slot 1 and slot 2 on the bottom. The rail track system and/or other computer components may utilize slot information as a type of container information that describes a container's location on a specific train car and/or in a specific area of rail yard.

For example, OCR portal 300 can be configured to read the container ID and/or other visual markings and wirelessly broadcast data associated with each container that moves through OCR portal 300. Using a series of sensors, such as cameras 304A-304F, the circuitry included in enclosure 308 and/or elsewhere can determine and record the slot of the container in train car 312.

An RFID reader 314 included in OCR portal 300 may also determine and record the train car ID of car 312 and correlate that to the containers and their respective slot location. The RFID reader can be configured to read, for example, active, passive, and/or semi-passive RFID tags on the side of the train cars, such as car 312. The data obtained by the RFID reader can be used in combination with other data, such as data stored in a look-up table of EDI data or UMLER data, to tell the rail tracking system and/or other system(s) about each individual car and/or shipment container that passes through OCR portal 300. Exemplary data about each train car that may be obtained via RFID includes the number of axles associated with each train car, the number of wells included in each train car, the length of the train car, the type of train car type, among other characteristics of the train car and/or its cargo.

Each train car can have one or more wells. A single rail car can include, for example, up to five or more wells. Car 312 can include more than one well. As referenced herein, train cars include joints that are configured to be disconnected and reconnected to other train cars' joints a number of times without damaging the train car, while wells of the same train car are configured to remain connected (unless, of course, damaged or destructed). The containers can be configured to sit in the wells as shown in FIG. 3. Each well may hold one or more containers such as the three shown in FIG. 3. For example, container 310A may be a forty to fifty-three footer (or any other suitable-sized) container, and containers 310B and 310C can each be 20 footer containers.

A single rail car may include, for example, three wells connected by articulated joints that do not separate, which may function in some aspects similar to three separate rail cars, but are considered a single rail car because the three wells are configured to remain connected and not disconnect. An articulated joint between wells may have, for example, a single axle adjacent thereto. An articulated joint between rail cars may have, for example, two axles where the rail cars disconnect from each other. Wells may articulate at the wheels without coming apart.

A collection of cars and corresponding wells can be moved onto the track as a single train and be divided into segments of individual or combined cars. For example, when a train is pushed or pulled onto a track under a RMG crane, all of the cars accessible to the RMG crane may not be connected.

Because a train can move back and forth thru one or more OCR portals before coming to rest on the track, a sensor (such as an axle counter that detects the number of axles and their direction) can be included in an OCR portal, such as OCR portal 300, and used with software logic to determine various information. For example, one or more sensors can be configured to observe and determine the type, number, and/or direction of the rail cars. As another example, the sensor can be configured to determine the train car ID and/or slot location of all containers on one or more wells and/or cars of the train.

Once the train passes through the OCR portal a number of the important details about that train and its containers are known (captured, processed and/or determined). Some embodiments of the present invention can be configured to utilize the information derived from observing and/or or otherwise communicating with a rail car and its containers as the rail cars, for example, pass thru the OCR portal. Upon subsequent identification (e.g., confirmation) of one of the containers in the working area, some embodiments of the present invention may already have stored and has access to information that may be independently confirmed or otherwise subsequently identified about each rail car and at least some of its contents. In this way, some embodiments of the present invention may provide information to direct an RMG to operate on that car and train.

After the train cars and wells move into the working area, some embodiments of the present invention may use instruments, detectors and others types of sensors included in the RMG crane, such as RMG crane 100 or 200, and/or elsewhere in the working area to find, detect, and characterize containers on each a rail car and/or in each well, and provide information to efficiently drive and/or otherwise move the RMG crane, such that the RMG crane is positioned over the container chosen to be worked (e.g., picked up, transferred, carried, weighed, confirmed, communicated with, etc.). Some embodiments of the present invention may use information provided from separate pole-mounted detection systems, among others, or combinations thereof.

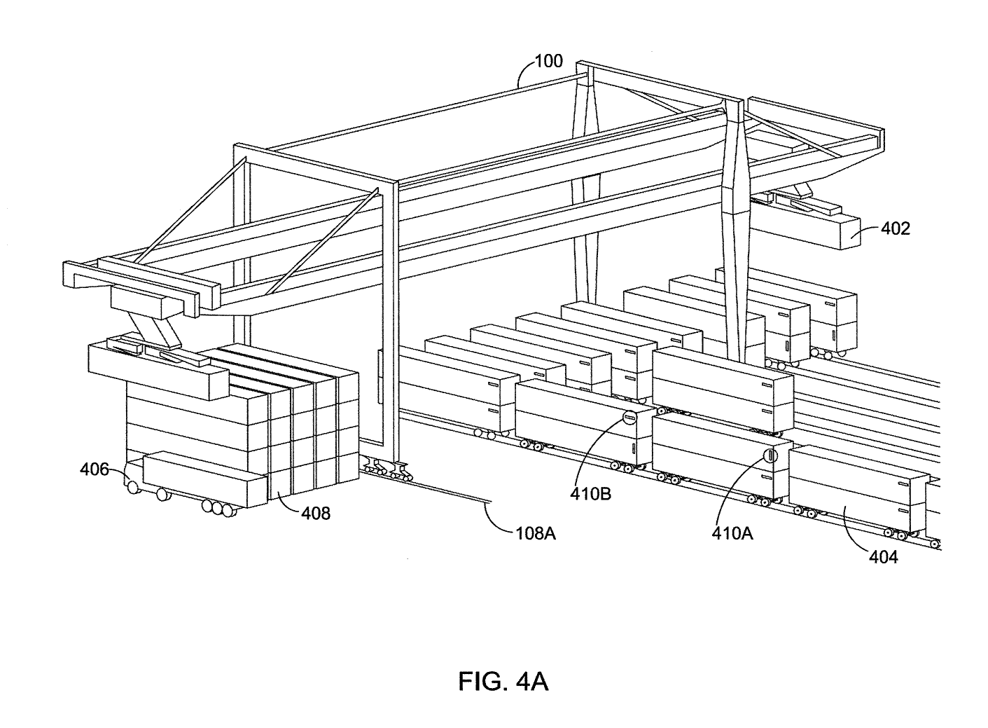

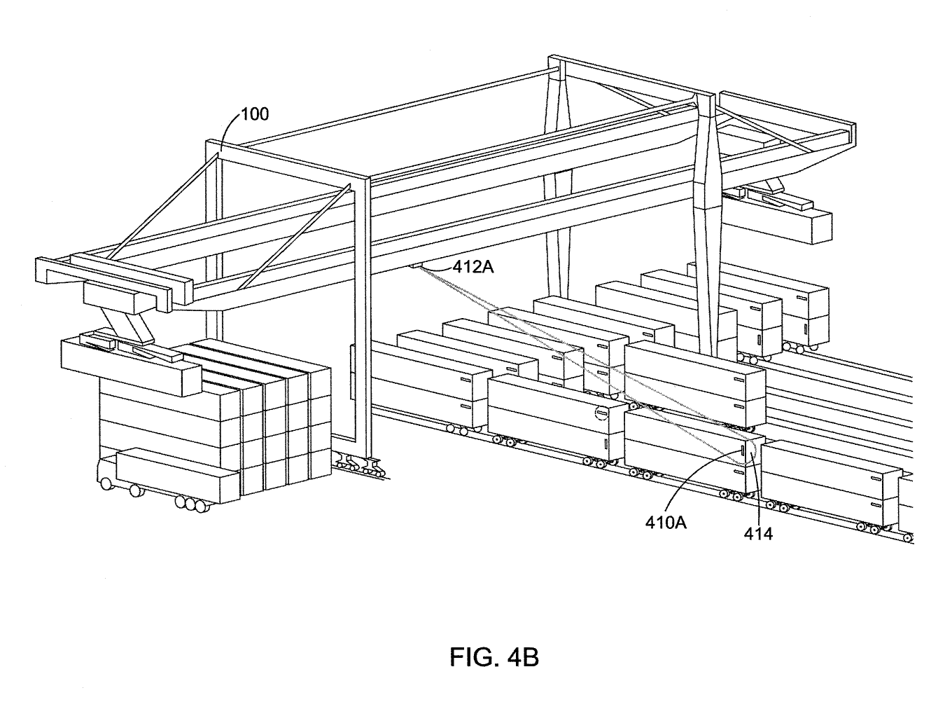

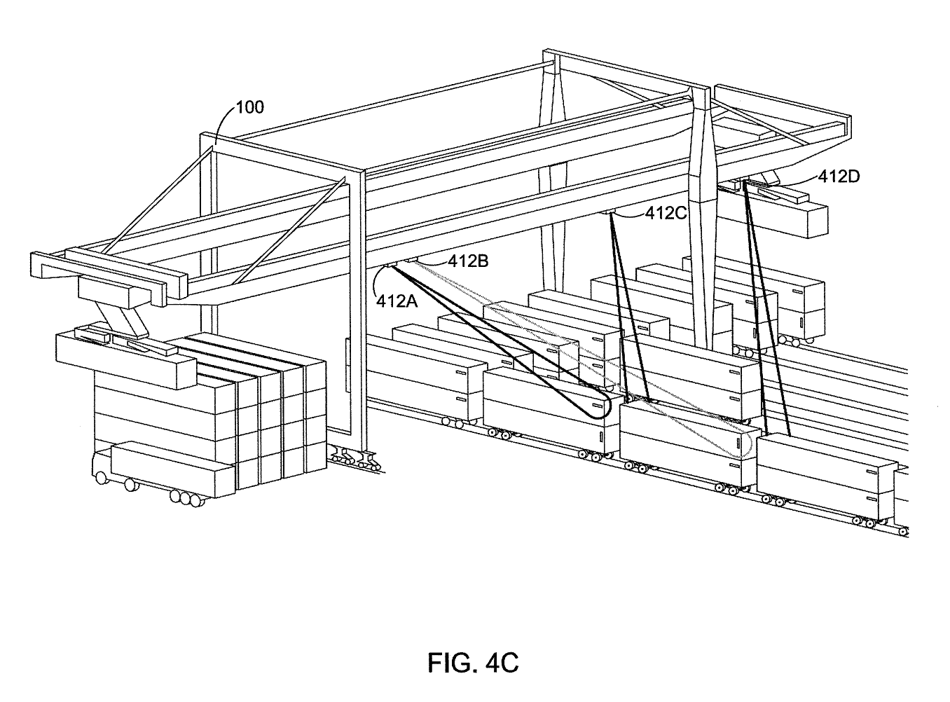

FIG. 4 shows RMG crane 100 of FIG. 1 receiving and working a string of train cars. As noted above, RMG crane 100 can move up and down tracks 108A and 108B. One measurement that may be determined and/or monitored (based on, e.g., observation, time and/or distance) is the train car's position on the track. For example, a track measurement can be made relative to the distance from the end of the track. As another example, train car position can alternatively or additionally be specified by a latitude-longitude position. To locate and/or work train cars based upon their position, RMG crane 100 may be equipped with a global positioning system (“GPS”), a system that measures its travel along the track (using, e.g., an encoder wheel), and/or any other type of system.

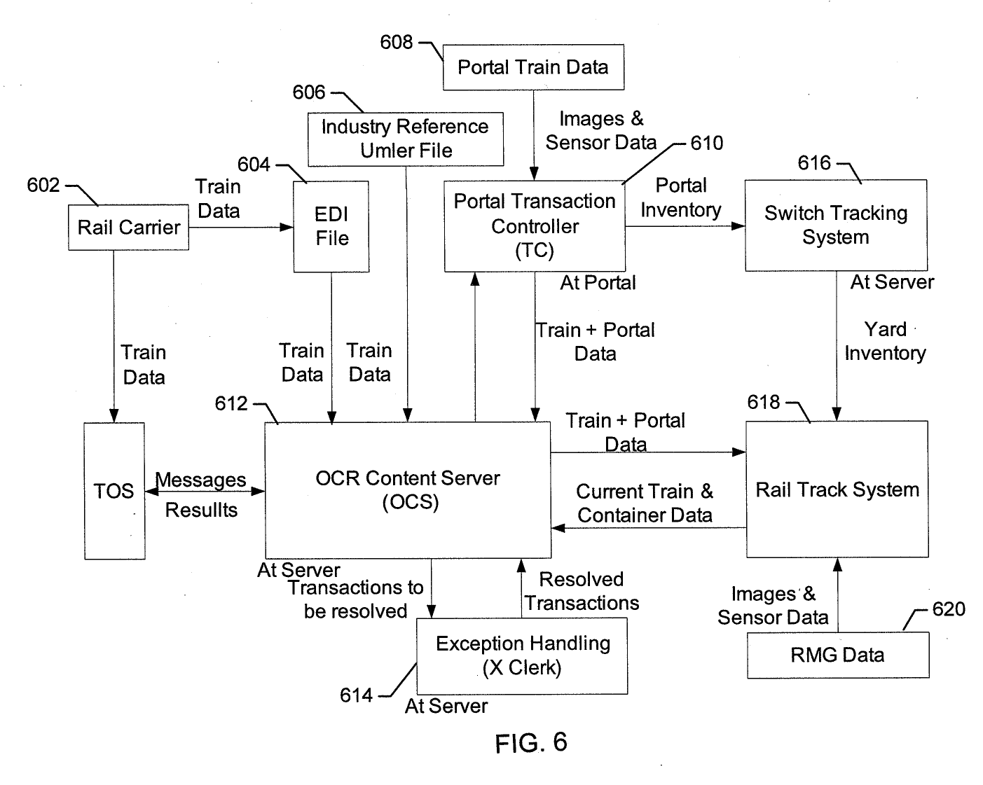

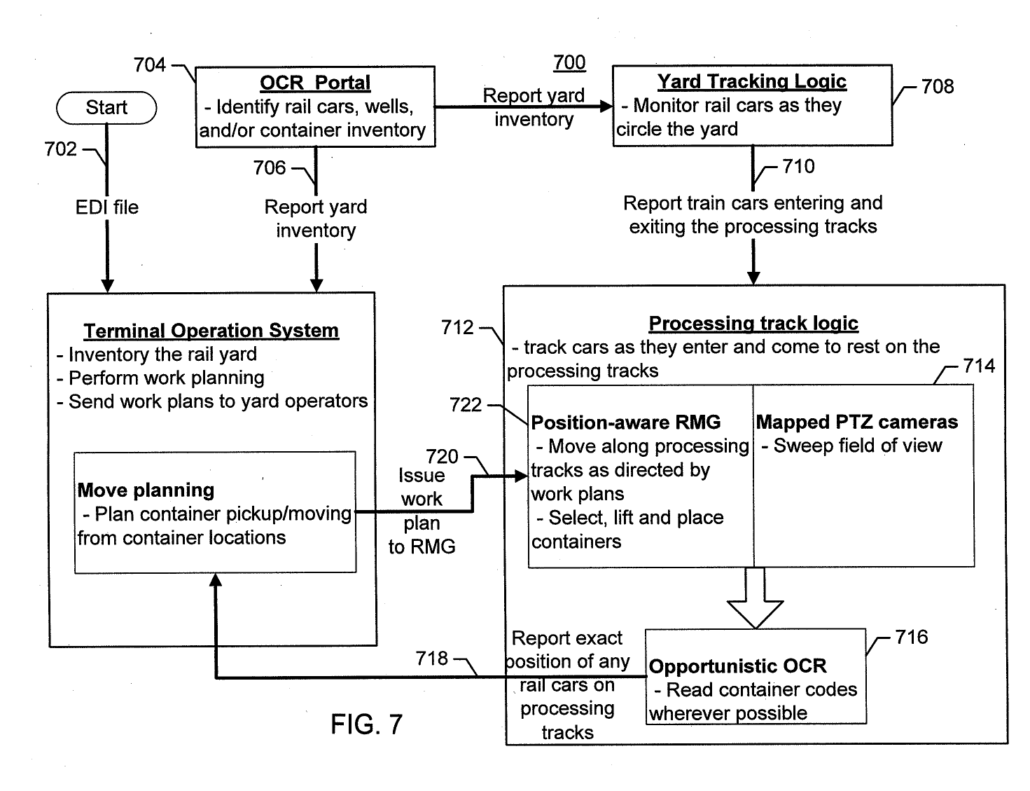

The RMG crane 100 may include programmable logic controller (“PLC”) that can be configured to control the actions, movement and other functionality of RMG crane 100. The PLC is one type of processor that may be included in RMG crane 100 that can be configured to determine, among other things, location information and twist lock status. In some embodiments, in addition or instead of using a PLC, RMG crane 100 may include a microprocessor or other type of processor, such as a coprocessor, a controller or various other computing or processing devices including integrated circuits such as, for example, an ASIC (application specific integrated circuit), an FPGA (field programmable gate array), a hardware accelerator, or the like. The PLC and/or other type of processor may be configured to execute instructions, such as those discussed in connection with FIGS. 6-7, stored in a storage device that is accessible to the PLC and/or other type of processor. As such, whether configured by hardware or software methods, or by a combination thereof, the PLC and/or other processor may represent an entity (e.g., physically embodied in circuitry) capable of performing operations according to embodiments of the present invention while configured accordingly.

RMG crane 100 may also include provisions for hoisting, trolleying and/or otherwise moving containers, such as container 402, to a position over a rail car, truck, and/or stack of other containers for loading and unloading of the train, such as train 404. FIG. 4A also shows the relationship among a train (e.g., train 404), tractor trailers (e.g., tractor trailer 406), container stacks (container stack 408), and container markings (markings 410A and 410B).

RMG crane 100 may also include cameras mounted thereon. For example, FIG. 4B shows a camera 412A mounted on RMG crane 100 and pointed towards a container on a rail car. Camera 412A can include, for example, a fixed camera, a Pan Tilt Zoom (“PTZ”) camera, and/or any other type of camera that may be pointed towards a container or maintain a wide field of view including numerous shipment containers.

In some embodiments, the circuitry of RMG crane 100 can determine the location of a container relative to the location of RMG crane 100, another container and/or another known location. For example, RMG crane 100 can be at a known track location, such as determined by an internal guidance system of RMG crane 100. Using geometry and/or sensors included in camera 412A (that measure the angle at which the camera is being directed), the location of the field of view 414 of camera 412A can be determined. For example, if marking 410A (which may include a container marking ID) is in field of view 414 of camera 412A, the location and other information related to that container can be determined and stored (locally within and/or remotely from RMG crane 100). RMG crane 100 may determine and store the track number and the relative distance to the container from RMG crane 100 and/or absolute position (e.g., based on a frame of reference used in the train yard, such as, e.g., track distance, Latitude-Longitude coordinates, among other absolute frames of reference). Similar functionality may be achieved using cameras not mounted to the crane, such as pole-mounted cameras, and providing data to the rail tracking system.

FIG. 4C shows a system in accordance with some embodiments of the present invention that include a plurality of cameras, cameras 412A, 412B, 412C, and 412D, positioned such that their fields of view collectively cover all or at least some of the train tracks under and/or otherwise accessible by RMG crane 100. Each of cameras 412A, 412B, 412C and 412D can be individually and/or collectively controlled manually and/or by an automated system included in RMG crane 100 and/or a system remote from RMG crane 100.

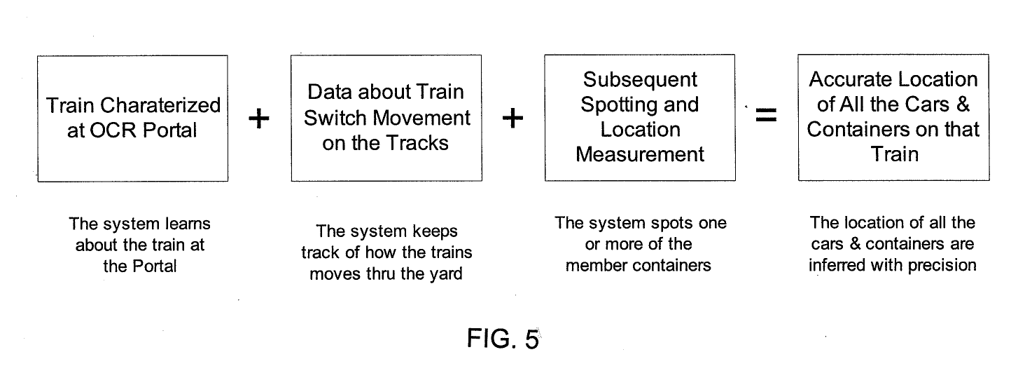

The information collected by one or more cameras and/or other sensors (e.g., RFID reader, proximity sensors, weight sensors, etc.) included on RMG crane 100 and/or elsewhere in the working area can be used in some embodiments to determine, compute, and infer, among other things, the location of a grouped series of container locations (e.g., the location of all the containers loaded on rail cars that are linked together in sequence) based on, e.g., the spotting, identifying, observation and/or measurement of just one of those containers. Because the sequence of grouped containers were observed, measured, and characterized at the OCR portal when they entered the facility, when just one of those containers is identified within the facility, the location of the other members of the group of containers can be accurately inferred through extrapolation. If more than one container in the group is spotted and its location determined and/or confirmed, then the precision of the of the group measurement increases accordingly. For example, FIG. 5 graphically shows the inputs to the system (e.g., initial characterization at OCR portal, information about the trains movement, and subsequent confirmation of at least one container's location) can be combined to produce a system output (e.g., a determination of the locations of the containers delivered by the train). In other embodiments, less or more inputs can be included and/or additional or different outputs may be produced.

The location of the RMG crane may be known (e.g., predetermined and/or fixed) and inputted into a rail tracking system (“RTS”). The rail track system may include the circuitry and other hardware of the RMG crane and/or be implemented in additional or alternative hardware, software and/or firmware. For example, the frame of reference of the RMG crane can the current location the RMG crane on the track (distance down the track) and/or as Latitude-Longitude coordinate. The mounting location of one or more cameras (included, e.g., on the RMG crane or poles, in the OCR portal, among other systems) may also be known and inputted into the rail track system. As yet another example, the orientation of one or more cameras may be known (e.g., where the camera is pointing). The field of view of each camera (which may include the objects within the respective field of view) may then be computed by the rail track system.

In some embodiments, more than one of the cameras may be able to see containers on the same train/track and/or see the same container. This may provides multiple views of the train contents and/or container IDs. In the event that a particular container marking is poorly visible to one camera, the multiple views of the same container may increase the likelihood of seeing and reading accurately the container's ID. The rail track system can be configured to combine images and information from several cameras.

In some embodiments, the image of the container ID can be transmitted to or otherwise sent to the rail track system to be interpreted using, e.g., a process and/or circuitry included in the OCR portal. The RMG crane and camera orientation data may also be sent to the rail track system for computation as a position value.

FIG. 6 shows a functional block diagram of system data flow provided by exemplary systems and methods in accordance with some embodiments of the present invention. Rail Carrier 602 can include circuitry (e.g., processor, wireless communications circuitry, wired-based communications circuitry, and/or any other suitable electrical components) configured to provide train data. For example, the train data can be contained in and/or formatted as an EDI file, such as EDI file 604.

Using, for example, a rail industry reference database universal machine language equipment register (“UMLER”) file, such as UMLER file 606, data from EDI file 604, portal data 608 (e.g., reference data and rail car ID) obtained by an OCR portal, data can be retrieved, determined, and/or outputted about one or more train cars. The retrieved and/or determined data may include information related to train cars (such as, e.g., car length, number of wells, configuration, etc.), train containers (such as, e.g., current location, contents, final destination, results of security or other types of analyses, expected location at a given future time, etc.) and/or other rail yard equipment (train rail switches, cranes, etc.). Rail management sensors can be configured to generate railway switch yard data. The rail management sensors may include, for example, axle counter sensors that may be positioned on both sides of a rail switch sensor and can provide an output indicating the size of each rail car and/or the direction that the train cars are being directed. Rail yard inventory can be established using, for example, the outputs of the axle counter sensors and/or rail switch outputs.

For example, portal train data 608 can be gathered at an OCR portal, processed by portal transaction controller 610, and passed to OCR Content Server (“OCS”) 612. At this point, in some embodiments, the system contains enough necessary information regarding the train and the equipment included thereon to determine future locations of one or more containers at one or more specific times in the future.

Exception handling system 614 can include a subsystem, module and/or other device that can be configured to receive, among other things, partial and/or incorrect data and resolving and correcting the data.

At least one switch tracking system 616 can also be included in the rail yard. Switch tracking system 616 can include hardware (e.g., electrical and/or mechanical switches) that can be configured to provide, for example, data about the train and each of its components (e.g., train cars, containers, etc.) as the components move through the switch yard. Switches throughout the rail yard can be used to, for example, break, join, and/or change the direction of train cars in the yard. This function can be performed within switch tracking system 616 using sensors and a set of data rules, and/or it can be performed by other systems. The outputs of switch tracking system 616 can be provided to and received by the rail track system 618.

Rail track system 618 may include software, hardware, and/or firmware configured to implement an electromechanical process that may include, for example, controlling one or more cameras and/or accepting RMG data 620 to, e.g., identify and locate containers on the rail cars. Rail track system 618 may also be configured to compute/infer the location of adjacent or otherwise related containers that may be grouped together. Rail track system 618 can be configured to report (e.g., format and transmit) its results to OCR Content Server 612. Alternately or additionally, rail track system 618 can use the processing functions of portal transaction controller 610 to process RMG crane camera images for OCR content. Images from the RMG crane cameras may also be made available to exception handling system 614, such as, for example, in response to determining that errors need to be processed and resolved.

As noted above, an RMG crane can include various types of components that may generate and provide RMG data 620 to the rail tracking system. For example, an RMG crane may include controllable cameras, which may be fixed and/or PTZ cameras, that may be used to gather images of container ID's of rail cars. The orientation of the cameras can be continuously monitored and can be used to compute the location of the field of view.

The RMG's PLC can be configured to provide RMG data 620 on the operation of the crane including such elements as, for example, trolley data (data associated with information on which track the head block is over, wherein the head block is the portion of the crane that latches onto the container), hoist data (data associated with information on the height of the head block), twist lock data (data associated with whether or not the head block is latched onto a container), and/or other data.

One skilled in the art would appreciate that the data transmissions represented by the arrows of FIG. 6 using wireless, wired, fiber, and/or any other type of connections.

FIG. 7 shows a combination of blocks representing system components and functional steps that may be executed by the system components. The arrowed lines connecting the steps and blocks represent, for example, commands and other types of data transmissions that may be sent and/or received by one or more components of a system in accordance with some embodiments discussed herein. Like other schematic block diagrams and flow charts discussed herein, FIG. 7's combination of blocks and steps can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the blocks and/or steps. These computer program instructions may also be stored in at least one computer-readable memory that can direct a computer or other programmable apparatus (such as, e.g., a PLC) to function in a particular manner, such that the instructions stored in each computer-readable memory produce an article of manufacture including instruction means which implement the functions specified in the blocks and steps. The computer program instructions may also be loaded onto a computer or other programmable apparatus to cause a series of operational steps to be performed on the computer or other programmable apparatus to produce a computer-implemented process such that the instructions that execute on the computer or other programmable apparatus provide steps for implementing the functions specified in the blocks and steps.

Accordingly, blocks and steps of FIG. 7 supports combinations of means for performing the specified functions, combinations of steps for performing the specified methods, and program instruction means for performing the specified functions. It will also be understood that one or more blocks or steps of the schematic block diagrams and flow chart, and combinations of blocks or steps in the schematic block diagrams and flow chart, can be implemented by special purpose hardware-based computer systems which perform the specified functions or steps, or combinations of special purpose hardware and computer instructions.

Process 700 of FIG. 7 may start with the sending of an EDI file at 702. The TOS may be configured to receive the EDI file. The EDI file can be transmitted via private, public and/or any other type of communications network(s). The received EDI file may provide the TOS, for example, information on one or more incoming and/or expected trains, such as its contents.

As an incoming train passes thru an OCR portal of a rail tracking system (which may be the same as or similar to an OCR portal discussed above, such as OCR portal 300), the OCR portal can identify at 704 the rail cars, the number of wells in each of the rail cars, information associated with one or more of the containers, and/or any other train identifying information. The train identifying information can be captured and associated with, for example, position data, speed data, and/or temporal data. The train identifying information, position data, speed data, temporal data, etc. can be stored in one or more storage media devices and/or reported to the TOS at 706.

For example, the train car ID of each rail car may be stored along with the time and location it was identified at 704. The TOS may be configured to keep an inventory of the rail yard and to update the inventory based on information received from the OCR portal. The each train car ID can be associated with, for example, an inventoried reference file and the TOS can be configured to determine additional information about the train car based on the reference file. The reference file may be initially inputted into the TOS (after, e.g., being requested or pushed from a remote device) and/or generated by the TOS (and/or one or more other components of the system shown in FIG. 7).

For example, one or more reference files can be published and made available by a railroad system, subsystem, or module that is located externally from the components shown in FIG. 7. The external system may be accessed over, for example, publicly available network for a fee or for free. The reference file can contain data about each train car and be indexed by, e.g., the train car ID number. For example, the number of wells, the car type, and length can be extracted from the publicly (or otherwise) available EDI file and inputted into the TOS of the rail track system for further logical operations and calculations.

As the train moves thru one or more other OCR portals and/or other yard tracking logic stations located elsewhere in the rail yard, an array of sensors (such as, e.g., axle counter sensors, cameras, switch sensors, etc.) a can be used at 708 to monitor and record the direction(s) and movement(s) of the train so that the actual cars (and their sequence) that end up on particular tracks are accounted for by the rail tracking systems. The OCR portal or other yard tracking logic station(s), for example, can monitor and log data at 708 that identifies which train cars (and/or shipment containers) are pushed and pulled back and forth thru the OCR portal as trains are assembled and dissembled on one or more tracks. The yard tracking logic stations can be configured to output, at 710, a report of the movement of the monitored train cars, containers, and/or segments to processing track logic. In some embodiments, the processing track logic can be integrated into the same device as the TOS and/or the yard tracking logic station. In other embodiments, the processing track logic can be integrated into a different device than the TOS and/or the yard tracking logic station.

In addition to or instead of the at least one OCR portal's sensor(s), a smart train car tracking system can be included in the yard tracking logic and perform step 706. The smart train car tracking system can be used, for example, within the rail yard to establish which track the individual cars (and/or their shipment containers) end up residing (after, e.g., the back and forth). When the smart systems are included in the rail yard, embodiments of the present invention can be configured to use, for example, electronic messaging (such as wireless communications) to obtain, for example, axle information, train car ID information, and/or any other information. When smart systems are omitted or are determined to be experiencing a functional error, embodiments of the present invention can be configured to employ (by, e.g., activating and/or utilizing outputs of) one or more axle counting sensors located throughout the train yard. For example, axle counting sensors can be located, e.g., before and/or after rail switch points. Any given track can end up with a diverse collection of trains, train segments (e.g., a group of train cars), and/or individual train cars, and the processing track logic can be configured to track cars at 712 as the train cars enter and each come to rest on a particular processing track. In this regard, each track in a working area or other portion of the rail yard may be numbered, named, and/or otherwise associated with any other type of identifying data. Using at least one OCR portal, axle counting sensor, and/or smart train container tracking system can enable the rail tracking system to determine, for example, the past, present and/or future track location of each train segment, train car and/or shipping container.

In some embodiments, despite the rail tracking system being able to determine and know on which track each of the train segments and/or individual shipment containers are located at any given time, the system may not know where on their respective track each is located. Each track could be, for example, thousands of feet long and hold hundreds of train cars and/or a number of train segments (e.g., groups of train cars from various or the same train) that are not connected to each other. As a result, in such embodiments, the problem may arise as to how to precisely locate the containers so that a RMG or other type of crane can be guided to the right spot to automatically (or semi-automatically) lift or discharge a container.

To avoid this potential problem of an automated system, some embodiments of the present invention may use a collection of techniques and inputs for a rail tracking system. Embodiments of the present invention can be configured to locate and identify at least one container in each contiguous string of train segments, train cars, and/or train wells. If, for example, the TOS only has access to information that identifies which train car is on which track without indicating where on that track, embodiments of the present invention can compute the location of the rest of the train segments, train cars, shipment containers, etc. For example, to find a first container, embodiments of the present invention may use a fixed or scanning camera (or camera array) that can look down or over one or more tracks at 714, find (e.g., search for, observe and confirm the identity of) a shipment container, determine container ID information, and record the position of the camera's field of view. In other words, some embodiments of the present invention can be configured to sweep a camera's field of view at 714, identify what container is being seen, where the camera is pointed, and map the location to the container ID information. This functionality can enable, for example, some embodiments of the present invention to have a starting point for identifying and/or confirming the final resting location of one or more specific train cars and/or shipment containers.

Opportunistic camera searching can also be performed at 716. For example, once a train car comes to rest in the rail yard, the rail tracking system will know which track each train car is on, and will know the location of the various RMGs in the yard. Tracks in the yard can be very long, for example, much longer than the train that just came to rest. The rail tracking system may or may not know which RMG or RMGs is/are close to the new train. The rail tracking system can monitors the position of each RMG crane (each RMG crane may be configured to span one or more rail tracks). The rail tracking system may also be configured to command the cameras (such as the activation and/or direction of PTZ cameras) to enter a scan mode and look for a container on that track that a RMG might be close to. In this manner, a new train car can be found, and a relative location of the associated RMG crane can be determined.

Once at least one container (or maybe 2-3 to improve precision) is found and/or location confirmed at 716, the rail tracking system can report the exact position of one or more train cars on processing tracks at 718 to the TOS. In some embodiments of the present invention, the rail tracking system can be configured to compute the locations of all the other containers in that same train segment/string based on the information previously received (at, e.g, 702 and 706). Commands may then be sent at 720 from the TOS to the RMG crane to guide it to the target container for hoisting.

Once the RMG crane latches on to the target container at 722, the known position of the crane can be used by the rail tracking system to correct or refine the previously computed container location. In this manner, the RMG crane can automatically and quickly move from container to container based on previous information and calculations done by the TOS and/or other aspects of the rail tracking system. Some embodiments of the present invention provide a missing link for RMG crane automation within a rail yard, thereby providing huge labor and time savings. Some embodiments of the preset invention can also use a wide variety of information to provide guidance locations for automation of cranes in a rail yard. In addition, the integration with an exception handling system may provide for up to 100% coverage of tracks (of at least a working area) so that nothing is missed or cannot be monitored by a rail tracking system in accordance with some embodiments. No other capability is known to exist like that provided by embodiments of the present invention.

Some of the advantages afforded by some embodiments of the preset invention include, for example, an efficient and accurate means to guide and direct a RMG to a specific container within a rail yard; the ability to provide accurate information within the rail yard so that efficient operational planning can be performed; the ability to provide post operational information suitable for audits; an integrated system that provides for information and logic redundancy along with an efficient means of handling and resolving any errors or exceptions. These and other advantages provide technical improvements in realizing additional automation of a rail terminal.

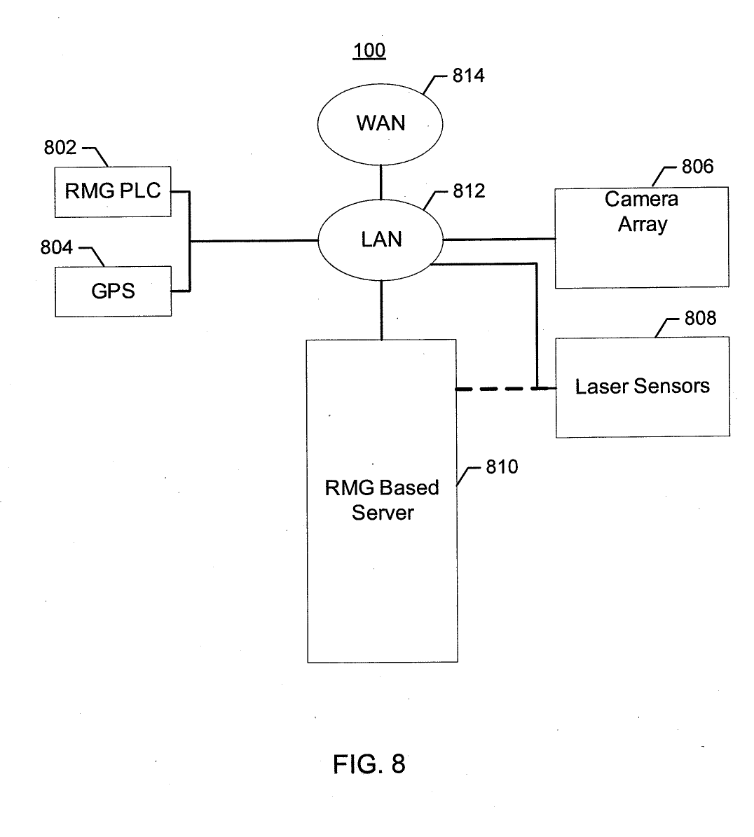

FIG. 8 shows an example of circuitry that may be included in RMG crane based equipment, such as RMG crane 100 discussed above. RMG PLC 802 can be, for example, a PLC used to control the RMG crane. RMG PLC 802 may provide crane data used by the rail tracking system. For example, RMG PLC 802 may provide data related to, among other things, hoist and trolley information (e.g., the location of the head block); twist-lock information (e.g., information related to whether or not the head block has attached to a container); and/or calibration sensors information (e.g., information used to periodically re-calibrate the hoist and trolley positions).

In some embodiments, a PLC tie-in may be included and function as a data link between RMG PLC 802 (and/or other component) that controls RMG crane 100 and the rail tracking system. The PLC tie-in can be configured to provide the rail track system (controllable and/or any other type of) access to the operation of the PLC and its sensor data.

RMG crane 100 may also include GPS 804. GPS 804 may be used to determine, for example, the position of RMG crane 100 based on its current global position. In some embodiments, GPS 804 may be a part of the RMG hardware in which case embodiments of the present invention would simply be a recipient of the shared data. Alternatively or additionally, GPS 804 may include separate global positioning-enabling hardware, software, and/or firmware.

Camera array 806 may include, for example, one or more fixed cameras (having, e.g., a known and calibrated orientation), PTZ cameras, and/or any other imaging device that can be configured to provide images to RMG crane 100 and/or other components of the rail tracking system. In addition to or instead of providing image data, camera array 806 may also be configured to provide orientation data indicating the orientation (pointing direction) of one or more cameras. In return, RMG crane 100 and/or other components of the rail tracking system can command, for example, a PTZ camera to point in a specified direction. The orientation of camera array 806 can be calibrated in some embodiments, and re-calibrated by being commanded to move to a specified field of view on the RMG (such as at, e.g., a predetermined and/or fix target).

Camera array 806 may be located on the RMG crane 100 at specified locations. Known, predetermined locations can aid in computing the field of view. For movable cameras (e.g., PTZ type cameras), the orientation of the movable camera(s) may be continually and/or periodically monitored to determine the camera's field of view.

RMG crane 100 may also include laser sensors 808, which may be either fixed beam, scanning beam and/or any other type of laser that may be used to provide, for example, train profile data. The train profile data and/or other data outputted by laser sensors 808 can be used as a backup source of data in some embodiments. In other embodiments, the data outputted by laser sensors 808 can be used as a primary source of data.

RMG based server 810 can be configured to provide for data collection and may include, for example, processing of image, sensor, movement command, and/or any other type of data that may be sent to or from RMG crane 100, such as to a rail tracking system. Alternatively, data can be collected by RMG based server 810 and transmitted to a more centrally located server that is configured to process the data and service multiple RMG based systems, such as to a rail tracking system.

LAN 812 includes, for example, communications circuitry that enables RMG crane 100 to access and/or provide a local area network that the other components of RMG crane 100 may utilize. Similarly, WAN 814 can include communications circuitry that enables RMG crane 100 to connect to, for example, a central, facility-wide and/or other type of wireless network.

In addition to the components shown in FIG. 8, other components included in rail track system can also include, for example, axle counters and/or RFID readers.

Axle counters and/or similar sensors may be located at, for example, the center of an OCR portal and, in the case of the switch yard, directly adjacent to the track switches. Axle counters can be configured to function within the yard to determine how many cars moved onto which track during the switching process. Some embodiments of the present invention (such as those that omit sensing or are experiencing a technical error preventing the sensing of which cars moved onto which track through the switch) may rely on an inferred process of counting cars and direction. For example, if five train cars move on a track at a switch and two train cars move off the track, the rail track system may determine that three train cars were left on the track.

RFID readers can be configured to, e.g., read the individual car ID tags. RFID readers may be scattered throughout the rail yard, and/or may be located at the OCR portal. Because RFID readers may be omitted from the working area of the rail yard, the axle counter array and/or other sensors can be used by the rail tracking system to keep track of movement.

As noted above, some embodiments of the present invention may be configured to utilize a standardized messaging system that enables, for example, the transfer (e.g., reception and transmission) of critical and/or other data elements and status indicators. External sources may include: an EDI file sent by the rail carrier prior to the arrival by a train (including, e.g., a forward train manifest of inventory expected in the yard, such as that discussed in connection with 702 of FIG. 7); an UMLER file and/or other type of file from an industry wide reference data base containing, e.g., technical information on each and every rail car (such as, e.g., car type, number of axles, length, number of wells, sequence of the wells, etc.); yard inventory that may be supplied by other components (such as, e.g., RailComm) which includes, for example, the track inventory of each track in the yard; and/or data from the RMG PLC that may include, e.g., data and other information described herein. For example, for a RailComm and/or other type of system to provide various information (such as yard inventory) to the rail tracking system, some embodiments of the rail track system may be configured to tell the RailComm what has already passed through one or more OCR portals of the rail tracking system. The RailComm may then track the cars through the yard till they come to rest.

Some embodiments of the present invention may also be configured to generate and/or provide information. For example, OCR data at the portal, including time, track, container ID, container location on the car/well, train car ID, direction of travel, etc., can be provided to one or more other systems and/or components. As another example, yard location information of a train car that is moving or at rest, such as the location of each container on a train in reference to a known, predetermined track position (such as, e.g., the distance to the end of the track) and/or using GPS coordinates can be provided to one or more other systems and/or components. Other types of information that can be provided to other systems include, e.g., statistical data (indicating, e.g., the performance of the system, confidence factors, etc.), image data that were collected and/or processed by the rail tracking system, camera orientation data, and/or PLC data.

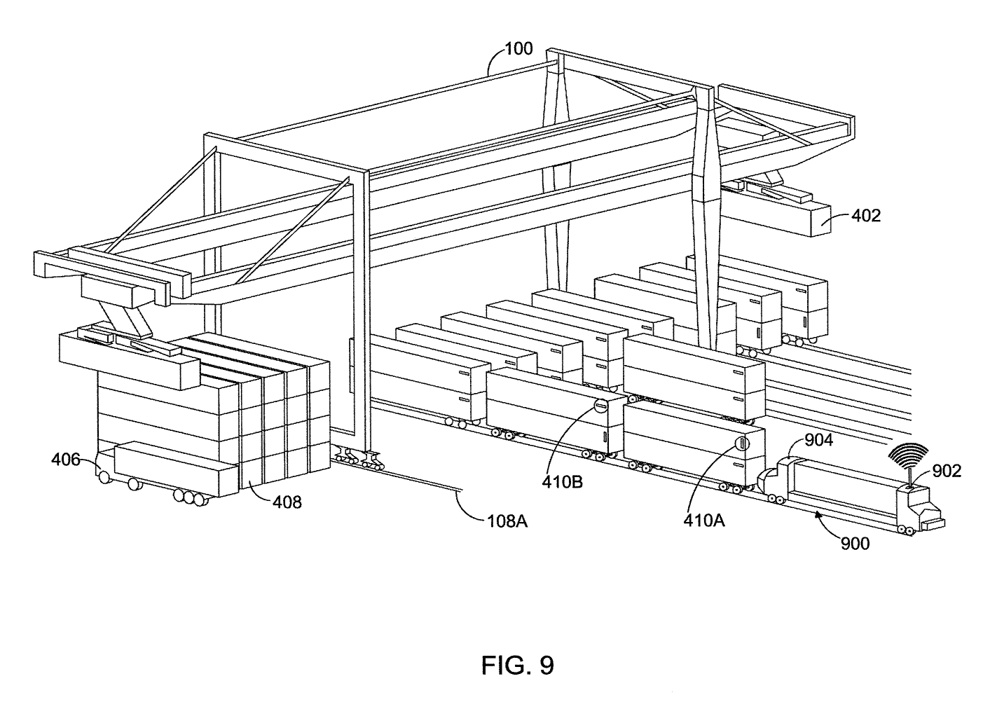

FIG. 9 shows a locomotive 900 that includes wireless communication circuitry 902 and a GPS receiver 904. Locomotive 900 may be any type of device that can pull, push, or otherwise move train cars, shipping containers, and/or other objects along tracks in a rail yard.

Wireless communications circuitry 902 may comprise hardware, software and/or firmware that enables wireless communications, such as, e.g., WLAN, Bluetooth, WiMAX, 3GPP long term evolution (“LTE”), ultra-wideband (“UWB”), infrared (“IR”), among other types of wireless technologies and protocols. Wireless communications circuitry 902 may also be configured to receive inputs and/or other electrical signals from GPS receiver 904 directly or indirectly from other circuitry included on locomotive 900 (e.g., from a processor and/or storage media). GPS receiver 904 may include hardware, software and/or firmware that enables locomotive 900 to determine its current global position coordinates, sometimes referred to herein as “locomotive location information.”

Alternate embodiments may employ a positioning system that does not use satellite or only partially uses satellites for positioning, and instead relies at least in part upon some other reference frame, such as ground-based positioning transmitters. For example, RFID-based locationing systems (such as electronic article surveillance systems), WiFi-based locationing systems, and/or cellular-based locationing systems may be used to generate locomotive location information (or rail car location information).

The locomotive location information may also identify past locomotive location(s) and may be provided to the rail tracking system using wireless communication circuitry 902. A locomotive identifier and/or any other information (e.g., expected future location(s), speed, time, direction, remaining fuel, fault messages, among other locomotive data that may be collected or otherwise generated by locomotive 900) can also or instead be transmitted to the rail tracking system using wireless communication circuitry 902. For example, locomotive 900 and/or one or more rail cars may include one or more car coupling sensors (which may be communicatively coupled to wireless communication circuitry 902) that may be configured to sense when a rail car or other object is coupled to and/or uncoupled from the locomotive and/or an adjacent rail car.

In some embodiments, rail cars may include an electrical connection (wireless or otherwise) that enables locomotive 900 to determine when a rail car, that is nonadjacent to the locomotive, is coupled to or uncoupled from another rail car. For example, the electrical connection may include mesh network communications, daisy chain communications, and/or any other communication protocol that relays information among nonadjacent devices.

In some embodiments, communication circuitry 902 can be configured to continuously transmit locomotive location information to the tracking system. Alternatively or additionally, communication circuitry 902 can be configured to transmit locomotive location information to the tracking system in response to one or more predetermined events, such as, for example, a rail car being coupled or uncoupled from locomotive 900 or another rail car.

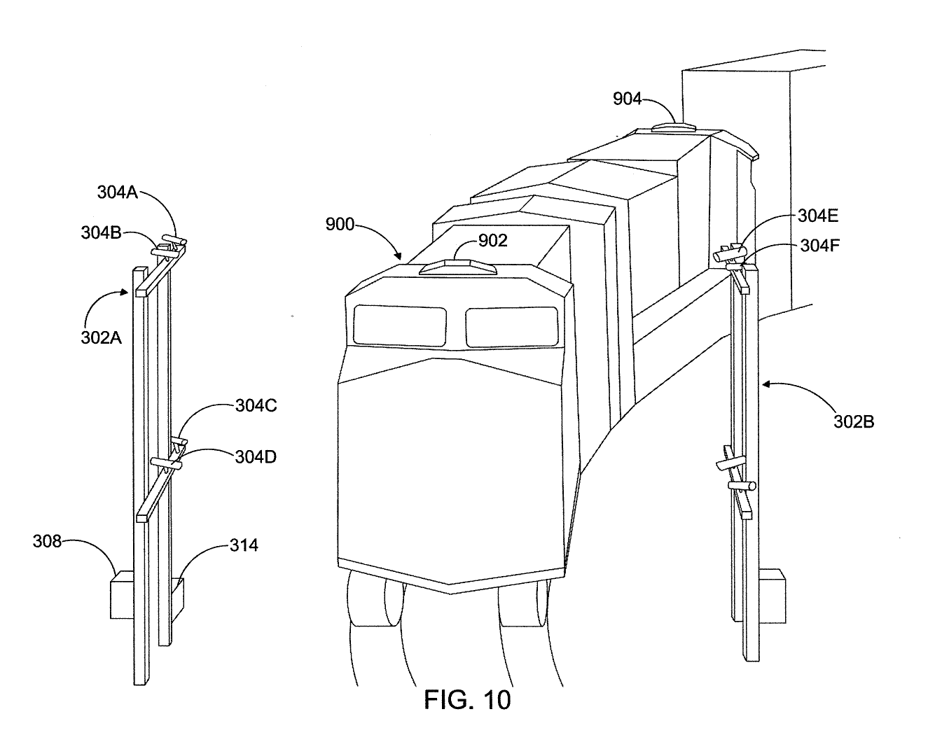

As shown in FIG. 9, locomotive 900 can determine its global position and/or transmit locomotive data while in the working area of a rail yard. Additionally or alternatively, as shown in FIG. 10, locomotive 900 may also be configured to transmit locomotive location information and/or any other information while passing through or otherwise within communication range of OCR gates 302A, 302B.

The rail tracking system can be configured to extrapolate the location of one or more rail cars and container(s) thereon based on the locomotive location information and/or other types of information, such as OCR data, UMLER data, axle count data, etc. In this regard, the rail tracking system can determine and/or confirm the absolute and/or relative location of rail cars and the containers that they hold. In some embodiments, the locomotive location information can be used instead of or in addition to data generated based on image data and associated camera angles. For example, the locomotive location information can be used by the rail tracking system to supplement data generated based on camera inputs for improved accuracy. As another example, the camera inputs to the rail tracking system can be (e.g., largely or wholly) disregarded unless the rail tracking system determines the locomotive location information is flawed. As yet another example, the locomotive location information can be used in response to the rail tracking system determining that the received camera input information is flawed (e.g., incomplete or faulty data, unreliable due to heavy fog or other type of bad weather, notified of a transmission error or camera malfunction, etc.).

As an alternative to or in addition to locomotive 900 comprising wireless communication circuitry 902 and/or GPS receiver 904, one or more rail cars being moved by locomotive 900 may include a GPS or other position determining sensor, similar to or the same as GPS receiver 904, and/or a wireless or other type of communications circuitry, similar to or the same as wireless communication circuitry 902. The rail cars may then be configured to generate “rail car location information” (similar to locomotive location information) and provide the same or similar functionality discussed in connection with locomotive 900. The rail cars may provide the rail car location information independently or collectively (e.g., one rail car has communication circuitry and another rail car as a GPS or other type of positioning circuitry) to the rail tracking system.

As another example, the GPS receiver functionality from the train could be combined with GPS from the crane and other location data to create and define “Safety Zones” around the yard for workers. For example, a GPS device may be placed on a locomotive or other type of train car for the specific purpose of rail tracking and/or to locate personnel in the vicinity of the RMG cranes in order to identify safety regions and dynamically establish unsafe zones that may not be breached by automated equipment, thereby automatically sensing and tracking moving trains and locomotives that present a safety hazard to workers on the ground in real time or near-real time.

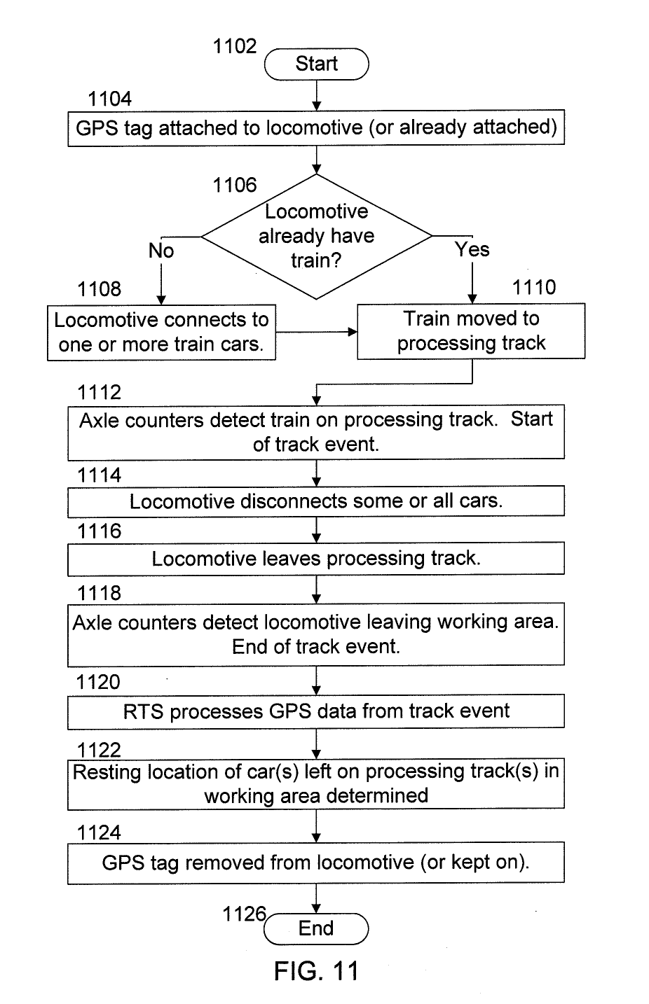

FIG. 11 shows a combination of blocks representing functional steps that may be executed by system components in accordance with some embodiments discussed herein. The arrowed lines connecting the steps and blocks represent, for example, commands and other types of data transmissions that may be sent and/or received by one or more components of a system in accordance with some embodiments discussed herein. Like other schematic block diagrams and flow charts discussed herein, FIG. 11's combination of blocks and steps can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the blocks and/or steps. These computer program instructions may also be stored in at least one computer-readable memory that can direct a computer or other programmable apparatus (such as, e.g., a PLC) to function in a particular manner, such that the instructions stored in each computer-readable memory produce an article of manufacture including instruction means which implement the functions specified in the blocks and steps. The computer program instructions may also be loaded onto a computer or other programmable apparatus to cause a series of operational steps to be performed on the computer or other programmable apparatus to produce a computer-implemented process such that the instructions that execute on the computer or other programmable apparatus provide steps for implementing the functions specified in the blocks and steps.

Accordingly, blocks and steps of FIG. 11 supports combinations of means for performing the specified functions, combinations of steps for performing the specified methods, and program instruction means for performing the specified functions. It will also be understood that one or more blocks or steps of the schematic block diagrams and flow chart, and combinations of blocks or steps in the schematic block diagrams and flow chart, can be implemented by special purpose hardware-based computer systems which perform the specified functions or steps, or combinations of special purpose hardware and computer instructions.

The process shown in FIG. 11 may start at 1102. At 1104, a GPS receiver or other type of locating device may be removably or non-removably attached to the locomotive and/or one or more rail cars of the train. In some embodiments, the GPS receiver or other type of locating device may already be attached the locomotive and/or rail car(s) and a determination can be made as to whether or not the locating device is functioning properly. If the locating device is not functioning properly or if an incompatible locating device is already attached, a proper, functioning locating device may be attached at 1104.

At 1106 a determination is made as to whether or not the locomotive already has train cars attached thereto. If not, the locomotive connects to one or more train cars at 1108. In some embodiments, the locomotive can be configured to transmit locomotive location information in response to connecting to one or more train cars.

If the locomotive already has train cars coupled thereto at 1106 or after connecting to train cars at 1108, the locomotive can move the train at 1110 to a processing track of the rail yard's working area. One or more axle counter(s) and/or other rail yard equipment can detect the train on the processing track at 1112, which may signal the beginning of a track event. The track event may comprise the rail tracking system actively monitoring and extrapolating data based on location and other information received by, e.g., the rail tracking system.

At 1114, the locomotive disconnects some or all of the train cars and at 1116 the locomotive (and, in some instances, the train cars that are still connected to the locomotive) leave the processing track. At 1118, one or more axle counter(s) and/or other rail yard equipment can detect the locomotive leaving the working area and cause the rail tracking system to determine that the track event has concluded. Although not shown in FIG. 11, 1112-1118 can be repeated as the locomotive moves among tracks within a rail yard (or elsewhere) and leaves train cars (for, e.g., processing by an RMG crane, pickup by another locomotive, inspection by security or other authorities, etc.).

At 1120, the rail tracking system can be configured to process location information received during the track event. In some embodiments, 1120 is performed simultaneously with one or more other functions shown in FIG. 11 and/or in response to determining that the track event has ended at 1118.

The resting location of train car(s) left on the processing track(s) of the working area accessible by a RMG crane can be determined by the rail tracking system at 1122. As noted above, the determination of 1122 can be based on other data the rail tracking system has received or can otherwise access (including, e.g., ULMER data, OCR portal data, etc.). The resting location of the train car(s) can be associated with, for example, the location of one or more RMG cranes, and various commands and/or information can be sent to the associated RMG cranes.

At 1124, removable GPS receivers or other type of locating device may be optionally removed from the locomotive and/or train car(s), and the process ends at 1126.

The data outputted by the rail tracking system in accordance with some embodiments may include, for example, a rail car ID with exact position on a track. Depending on requirements, this may be the rail car name itself, the container ID and/or any other identifying data. The position information may include, e.g., GPS data, track ID with offset distance from a switch and/or end of the track, and/or any other type of data having sufficient precision to allow, for example, a device, such as an RMG crane, to locate and, in some embodiments, physically lift a shipment container.

Some embodiments of the present invention can be configured to use a series of message types which is a part of an OCR process. For example, some embodiments of the present invention may use the OCR system of U.S. Pat. No. 7,508,956. These message types can be transmitted to a TOS. For example, in response to a rail car being identified through, e.g., a portal using the RFID tag on the car, some embodiments of the present invention can be configured to match that car ID up with the data in the UMLER file database. Some embodiments can be configured to populate a table with such data.

OCR portal scanning can be used to identify container IDs. For example, each camera's location and/or orientation along with the position in the frame taken can be mapped into the position on the track. The container ID can then be linked to the rail car ID by the rail tracking system, as can the position of the container on the car, using the portal data.

The rail track system can be scaled for more than one train, such as when a determination is made that multiple trains passed through the switch. The design of the rail tracking system can be configured to permit simultaneous train/track activity to be monitored. Given the switches in the yard, more than one train can also be built simultaneously, so more than one track can be operational.

Different trains can be identified and distinguished and/or tracked by the rail tracking system. Individual train cars, for example, can be tracked by their ID number (captured through the RFID reader at the portal), and collections of train cars (such as trains, train segments, etc.) can have their own designated identifiers.

Some embodiments may be configured to account for train cars having different numbers of axles. For example, in response to identifying a train car, information associated with the rail car can be retrieved from a reference data base (such as, e.g., the train car's UMLER file) where the number of axles is described. As the process continues, the axle data can be linked to that car and becomes an input to the logic. In other embodiments, the rail tracking system can be configured to count the spacing of the axles to independently and automatically determine where one train car ends another begins (e.g., two axles in relatively close proximity may indicate a connection between train cars, whereas a single axle may indicate a junction of two wells of the same train car).

Some embodiments of the present invention may also be configured to use scan-line technology. For example, image data, such as for OCR portal rendering of container identification, can be captured using area (two-dimensional) cameras of objects that appear in the visible foreground of the field of view. However, additional information may be captured from moving objects that are obscured in the background of the field of view, such as where the moving object is a train moving in the background behind a train at rest in the foreground. Although a two-dimensional area scan image may not be available for the background train, at any given moment in time a portion of the background train may be visible through a gap in the foreground train. The gap represents a thin vertical slice field of view of the background train, i.e., a scan line. A vertical line of pixels in the gap may be used to periodically capture an image of the entire portion of the background train that passes behind the gap. In a situation where the movement of the background object is known, such as in a train moving along a fixed railway, the individual vertical lines of pixels that are periodically captured may be reassembled side-by-side to create an assembled two-dimensional image of the portion of the background train that passes behind the gap. Software, hardware and/or firmware may be used to assemble the two-dimensional image from the vertical scan lines. If such functionality is desired (to capture additional information of background moving objects), even if only for opportunistic additional data capture of background trains when a foreground train is at rest, some embodiments of the present invention may be configured either to use a single vertical line of pixels of an area scan camera or a specialized line scan camera. If the resolution of the vertical line of pixels is adequate, some embodiments of the present invention may be able to perform OCR portal on the containers that pass behind the gap, thereby increasing the available data for further visibility and derived knowledge of the trains and containers in the railway switch yard.

As discussed in connection with, e.g., FIGS. 4A-4C, some embodiments can be configured to compute the location of a container using a PTZ camera. For example, sensors can be included on the camera to determine “pointing angles”, knowing camera location, and using trig calculations, a location of a container or other rail yard equipment can be determined. Since the camera moves and the RMG crane moves, additional calculations may be made in real (or near real) time.

Also as discussed herein, some embodiments can be configured to compute the location of a container using a fixed camera. This functionality may be implemented similarly to that discussed in connection with PTZ cameras, except that the cameras are fixed so they do not change with respect to the RMG crane. With a fixed camera, the position of the RMG crane may change. This change can be accounted for. Embodiments of the present invention can utilize, for example, calculations using trigonometry to do so. PTZ and/or fixed cameras may also be mounted to fixed locations that do not change, such as a pole or to a moving structure (e.g., service truck).

Some embodiments can be configured to extrapolate to compute the location of the one or more train cars, shipment containers and/or other equipment in, for example, in a contiguous string in which at least one piece of equipment has a known and/or confirmed location. Various information known by the rail tracking system about the train cars and other equipment can be applied to make such an extrapolation. For example, the distance between cars, the distance from well to well, the number and placement of axle may be known and used to make an extrapolated determination. Once the rail tracking system spots and locates, e.g., at least one container in a well, embodiments of the present invention may be configured to determine the location of the next one based on, e.g., a known distance. As another example, once the RMG PLC notifies the TOS that the RMG crane has latched onto the container that was previously identified, embodiments of the present invention can use location data from that transaction to adjust or correct reported locations of other train cars, shipment containers, and/or other equipment in the working area of the rail yard (and/or elsewhere).

Some embodiments can be configured to provide information redundancy across functionalities discussed herein. For example, embodiments of the present invention may provide redundancy by virtue of multiple cameras looking at the same or different containers in line, on the same train and/or otherwise situated relative to each other. This redundant data can be used to refine previously reported position so that the rail tracking system tracking and locating functionality is more accurate and precise than if redundancy was not implemented or is not functioning properly.

Some embodiments can be configured to provide logic redundancy. For example, embodiments of the present invention can include logic redundancy in that embodiments of the present invention know what components are about to seeing and/or interact with, and embodiments of the present invention can be configured to compare what is anticipated (and/or inferred) to occur at a given future time and what is actually present at the given time.

Some embodiments can be configured to provide exception handling. While some embodiments of the rail tracking system may be less than 100% accurate based on machine sensing and inference, in at least some instances, when data is missing or when an OCR portal is known to be wrong (such as when part of a container identification is obscured, faded, etc.), the rail tracking system may execute an integrated process for using transaction, sensor, image, and/or other data presented to a human operator for resolution. For example, XClerk is a software system that causes a machine to execute a process of handling data, recognizing potential errors, presenting it to an operator for resolution, and integrating that corrected data back into the system. For example, OCR data at the portal may be incomplete. In this case images from the transaction may be presented to an operator for review and resolution. Once this new data is acquired, it goes back into the process being executed by the rail tracking system.

Embodiments of the present invention may have trouble spotting a new train on the track in some situations. For example, there may be no nearby RMG cranes or other camera wielding components of the rail tracking system that may provide opportunistic scanning. In such instances, a manual operator can use an overhead, light-pole mounted (or hand or vehicle mounted) camera to identify the location of a rail car and “mark” that location so that an RMG can be re-directed and moved to the new rail car.

There are a variety of ways that errors can occur. Accurate locationing and tracking may depend on a number of data elements and processes to be completed and accurate. The following are some examples. As a first, in response to determining that OCR images do not result in a good read, the images presented to a clerk for human reading and re-input (manually using, e.g., a keyboard or other user interface) into the system. As a second example, in response to determining RFID tags were not read correctly at the portal, supporting data (which may be manually collected by a person in the rail yard) can be presented to a clerk for review and correction. As a second example, in response to determining a camera on a RMG crane is unable to read/OCR any container in a train string, a clerk may help to manually identify and or read the container ID and re-enter the data (using one or more user interfaces). Handling exceptions may involve: knowing that an error or omission has occurred; providing an interface to a clerk so that they can easily view supporting data used in the correction; and providing an human interface (mouse, keyboard, display screen, and network connection) so that re-imputed data flows back into the system in a seamless manner from the rail track system perspective.

The switch tracking system can be configured to monitor one or more of the switches, and report when the train has come to rest (e.g., temporarily “fixed” position in the working area of the rail yard) and positioned such that a secondary OCR station (the first OCR system being located at the switch and/or OCR portal) to locate and/or confirm the location of the shipment container. If a find-scan is initiated and the train starts to move, the switch tracking system can be configured to report it.

Subsequent movement of train cars in the switch yard can be tracked as described above. For example, data and messages from the switch tracking system can be used to determine the movement status of the train and/or component thereof. The switch tracking system can be configured to, for example, determine when a locomotive has entered or left the track. This type of determination (and others) can become part of the rules.

As mentioned above, pole mounted cameras can be included in some embodiments. Pole mounted cameras can be used, for example, by clerks to find trains along the track that have not yet been found by the cameras on the RMG crane or otherwise integrated into the rail track system. The clerk can find the train and report its “section location” into the system using the exception handling system. Alternatively or additionally, some embodiments of the present invention could have automated cameras on the poles providing a scan OCR function looking to read container IDs. In this case, the pointing location (e.g., field of view) can be provided.

Each computer system employed by the present invention may include any suitable processing device, such as a computer, microprocessor, RISC processor (reduced instruction set computer), CISC processor (complex instruction set computer), mainframe computer, work station, single-chip computer, distributed processor, server, controller, micro-controller, discrete logic computer, or like processor, as are known in the art. For example, the processing device may be an Intel Core™ or Pentium® microprocessor, other x86 compatible microprocessor, or equivalent processing device.

Each memory subsystem may include any suitable storage components, such as RAM, ROM, EPROM (electrically programmable ROM), flash memory, dynamic memory, static memory, FIFO (first-in first-out) memory, LIFO (last-in first-out) memory, circular memory, semiconductor memory, bubble memory, buffer memory, hard disk memory, optical memory, cache memory, database memory, and the like, as are known in the art. Any suitable form of memory or storage or memory subsystem may be used whether fixed storage on a magnetic medium, storage in a semiconductor device, or remote storage accessible through a communication link.

A user interface may be included in or coupled to the computer system and may include various user input devices, such as buttons or switches selectable by the user, a keyboard, a mouse, a touch screen, bar code scanner, RFID reader (or reader/writer), or like user input devices, as are known in the art, separate and in addition to the various sensor employed by other components of the overall system, such as OCR video or photographic devices, an RFID reader for rail cars, axle counter sensors, laser sensors, crane sensors, and external devices, such as a GPS receiver. The user interface also may include one or more suitable user output devices 10, such as an LCD display, a CRT, various LED indicators, a speech output device, and like data output presentation devices, as are known in the art.

Functions described herein and illustrated by functional blocks of diagrams may be encoded in control logic (software code) stored on a computer-readable and computer-useable medium, thereby creating a computer program product. Individual functions may be encoded in separate control logic and/or stored at and on separate computer-readable mediums. The functions may be part of firmware, software, or other control logic, which are collectively referred to in general herein interchangeably as software, functions, and software functions without specificity to the type of computer-readable medium in which the software, function, or software functions are stored in encoded control logic.

A computer program product for performing one or more functions of embodiments of the present invention may include a computer-readable and computer-useable storage medium, such as the non-volatile storage medium, and software including computer-readable program code logic portions, such as a series of computer instructions, embodied in (stored on) the computer-readable and computer-useable storage medium. Similarly, embodiments of the present invention may be incorporated into hardware and software systems and subsystems, combinations of hardware systems and subsystems and software systems and subsystems, and incorporated into network devices and systems and mobile stations thereof.

In this regard, each block or step of the present invention, such as functions of the schematic block diagrams and the flow chart, and combinations of blocks and steps, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the blocks and steps. These computer program instructions may also be stored in a computer-readable memory that can direct a computer or other programmable apparatus to function in a particular manner, such that the instructions stored in the computer-readable memory produce an article of manufacture including instruction means which implement the functions specified in the blocks and steps. The computer program instructions may also be loaded onto a computer or other programmable apparatus to cause a series of operational steps to be performed on the computer or other programmable apparatus to produce a computer-implemented process such that the instructions that execute on the computer or other programmable apparatus provide steps for implementing the functions specified in the blocks and steps.

Accordingly, blocks and steps of the schematic block diagrams and flow chart support combinations of means for performing the specified functions, combinations of steps for performing the specified functions, and program instruction means for performing the specified functions. It will also be understood that one or more blocks or steps of the schematic block diagrams and flow chart, and combinations of blocks or steps in the schematic block diagrams and flow chart, can be implemented by special purpose hardware-based computer systems which perform the specified functions or steps, or combinations of special purpose hardware and computer instructions.

The present invention may be implemented with various applications of wired and wireless direct, indirect, and networked communications and protocols for establishing and conducting communications between any two or more of the elements of an embodiment of the present invention, including, for example, WLAN (including communications compliant with one or more IEEE 802.11 protocols), Bluetooth (including communications compliant with one or more IEEE 802.15 protocols), WiMAX (including communications compliant with one or more IEEE 802.16 protocols), LTE, UWB, IR, other types of cellular wireless technologies, and/or any other wireless protocols, as well as serial, parallel, and Ethernet wired technologies and protocols, and IEEE 1394 and/or USB direct connection technologies and protocols. Further, embodiments of the present invention may function with any type of co-located (coexistent or proximate) or distributed (remote) architecture. Computing devices need not be physically co-located. Similarly, embodiments of the present invention may use shared hardware (e.g., processor, memory, and power) or software (e.g., operating system, firmware, software print drivers, print rendering subsystems, and applications) or may use separate hardware, whether co-located or distributed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications, equivalents, and other embodiments are intended to be included within the scope of the appended claims.

That which is claimed:

1. A method, comprising
automatically detecting a rest position for each of a plurality of containers transported by at least one rail car of at least one train in a working area of a rail yard, wherein the working area is accessible to at least one rail mounted gantry crane; and
transmitting container identification information and container location information to a terminal operating system.

2. The method of claim 1, further comprising operating the rail mounted gantry crane based at least in part upon the container identification information and the container location information.

3. The method of claim 2, wherein the operating of the rail mounted gantry crane includes moving to a location associated with the container location information.

4. The method of claim 2, further comprising receiving, by the rail mounted gantry crane, a command from the terminal operating system, wherein the command influences the operating of the rail mounted gantry crane.

5. The method of claim 4, wherein the operating of the rail mounted gantry crane includes:
identifying a container ID associated with a container; and
determining whether the container ID is associated with the container identification information.

6. The method of claim 5, wherein the operating of the rail mounted gantry crane includes:
determining the container ID corresponds with the container identification information; and
lifting the container associated with the container ID.

7. The method of claim 2, wherein the operating of the rail mounted gantry crane includes:
generating new container location information, and
transmitting the new container location information to the terminal operating system.

8. The method of claim 7 further comprising updating a record by the terminal operation system, the record associated with the container identification information to include the new container location information.

9. The method of claim 1, further comprising:
identifying a container ID associated with a container;
determining the container ID corresponds with the container identification information; and
in response to determining the container ID corresponds with the container identification information, determining a location of other containers based on the other containers' positioning relative to the location of the container.

10. The method of claim 1, wherein the automatically detecting the rest position of the plurality of containers includes using at least one of a camera and radio frequency identification reader.

11. The method of claim 1, wherein the automatically detecting the rest position of the plurality of containers includes extrapolating information based on a confirmed location of at least one of the plurality of containers.

12. The method of claim 1, wherein the automatically detecting the rest position of the plurality of containers includes extrapolating information from data generated by an optical character recognition portal.

13. The method of claim 1, wherein the automatically detecting the rest position of the plurality of containers includes extrapolating information from switch track data.

14. The method of claim 1, wherein the automatically detecting the rest position of the plurality of containers includes extrapolating information based on locomotive location information determined by a locating device.

15. The method of claim 1, wherein the automatically detecting the rest position of the plurality of containers includes extrapolating information based on rail car location information determined by a locating device.

16. A method, comprising
identifying individual objects carried by a plurality of sequential components of a transportation device;
determining the relative positions of the objects on the plurality of sequential components;
tracking the plurality of sequential components through a switch;
identifying at least a first one of the individual objects beyond the switch on a first path;
determining a rest location of the first individual object; and
determining a rest location of other individual objects on the first path.

17. The method of claim 16, wherein the tracking of the plurality of sequential components through a switch, comprises determining the plurality of sequential components have been distributed among two or more tracks and wherein the method further comprises:
identifying a second one of the individual objects beyond the switch on a second path;
determining a rest location of the second individual object; and
determining a rest location of the other individual objects on the second path.

18. The method of claim 16, wherein the determining the rest location of the other individual objects on the first path includes extrapolating information based on the rest location of the first individual object.

19. The method of claim 16, wherein the determining the rest location of the other individual objects on the first path includes extrapolating information from data generated by an optical character recognition portal.

20. The method of claim 16, wherein the determining the rest location of the other individual objects on the first path includes extrapolating information from switch track data.

21. The method of claim 16, wherein the determining the rest location of the other individual objects on the first path includes extrapolating information based on location information associated with a device that moved at least one of the individual object to the first path.

22. A rail tracking system, comprising
a processor configured to:
detect a rest position for each of a plurality of containers transported by at least one rail car of at least one train in a working area of a rail yard, wherein the working area is accessible to at least one rail mounted gantry crane; and
transmit container identification information and container location information to a terminal operating system.

23. The rail tracking system of claim 22, wherein the processor is further configured to:
determine a container ID corresponds with the container identification information, wherein the container ID is associated a container at a location that corresponds with the container location information; and
in response to determining the container ID corresponds with the container identification information, determine locations of other containers based on the other containers' positioning relative to the location.

24. The rail tracking system of claim 22, wherein the processor is further configured to detect the rest position of the plurality of containers by extrapolating information from data generated by an optical character recognition portal.

25. A rail tracking system, comprising
a processor configured to:
detect a rest position for each of a plurality of containers transported by at least one rail car of at least one train in a working area of a rail yard, wherein the working area is accessible to at least one rail mounted gantry crane; and
transmit container identification information and container location information to a terminal operating system.

26. A method comprising determining location information of a train car based upon location information provided by a locating device on a locomotive, wherein the location information is of sufficient precision to allow a RMG crane to locate the train car.

27. The method of claim 26 further comprising wirelessly transmitting the location information to a rail track system while the train car is in motion.

28. The method of claim 26, wherein the determining the location information further comprises utilizing:
RFID information identifying an ordered sequence of train cars that includes the train car, wherein the RFID information was received by an RFID reader at an OCR portal, and
length information identifying a length associated with each of the train cars, wherein the length information was received from a database.

29. A method comprising determining location information of a first train car based upon location information provided by a locating device on a second train car, wherein the location information is of sufficient precision to allow a RMG crane to locate the first train car.

30. The method of claim 29, wherein the determining the location information further comprises utilizing:
RFID information identifying an ordered sequence of train cars that includes the first train car and the second train car, wherein the RFID information was received by an RFID reader at an OCR portal, and
first length information identifying a first length of the first train car and second length information identifying a second length of the second train car, wherein the first length information and the second length information was received from a database.
